(19) United States
(12) Patent Application Publication
(10) Pub. No.: US 2012/0127140 A1
(43) Pub. Date: May 24, 2012

(54) MULTI-MODE LIQUID CRYSTAL DISPLAY WITH AUXILIARY NON-DISPLAY COMPONENTS

(76) Inventors: John Ryan, Sausalito, CA (US); Ruibo Lu, San Bruno, CA (US); Carllin Vieri, Menlo Park, CA (US); Mary Lou Jepsen, Sausalito, CA (US)

(21) Appl. No.: 13/155,151

(22) Filed: Jun. 7, 2011

Related U.S. Application Data
(60) Provisional application No. 61/415,749, filed on Nov. 19, 2010.

(51) Int. Cl. G09G 3/36; G09G 5/02; G02F 1/1333

(52) U.S. Cl. 345/207; 349/84; 345/102

(57) ABSTRACT

A liquid crystal display, alone or in combination with any kind of computing device, may comprise a plurality of pixels, each pixel comprising a plurality of sub-pixels, each sub-pixel comprising a transmissive part and a reflective part, wherein a cross sectional area of the reflective part is greater than half of a total cross sectional area of an entire size of that sub-pixel; one or more auxiliary components that are in a non-transmissive part of the sub-pixel and that are configured to provide one or more auxiliary functions that do not affect optical performance of that sub-pixel. In various embodiments the auxiliary components are electronic digital memory logic or drivers; electronic high refresh rate logic or drivers; touch sensor elements, and the display further comprising a touch panel sheet over the pixels; light sensors; photodiodes; photovoltaic solar power generating cells; organic light emitting diodes.

### BENEFIT CLAIM

This application claims the benefit, under 35 U.S.C. 119(e), of prior provisional application 61/415,749, filed Nov. 19, 2010, the entire contents of which are hereby incorporated by reference for all purposes as if fully set forth herein.

### CROSS REFERENCE TO RELATED APPLICATIONS

This application is related to U.S. patent application Ser. No. 12/510,485, filed Jul. 28, 2009, the entire contents of which are hereby incorporated by reference for all purposes as if fully disclosed herein.

### TECHNICAL FIELD

The present disclosure relates, in general, to a display. More specifically, the disclosure relates to a multi-mode Liquid Crystal Display (LCD) with auxiliary components.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Some multi-mode transflective LCDs, such as specific triple mode transflective LCDs, may be able to show color images in the transmissive mode and the transflective mode, and black and white images in the reflective mode, or operate as a pure transmissive LCD with unit pixels each having a transmissive part surrounded by other non-transparent, opaque and non-active areas. Such transflective LCDs, such as those that are commercially available from licensees of Pixel Qi Corporation, San Bruno, Calif., use pixels that have a relatively large reflective area, a large bottom metal layer for shield light and providing gate and data lines and/or backlight recirculation functions.

### BRIEF DESCRIPTION OF THE DRAWINGS

Various embodiments of the present invention will herein after be described in conjunction with the appended drawings, provided to illustrate and not to limit the present invention, wherein like designations denote like elements, and in which:

FIG. 1 is a schematic of a cross section of a sub-pixel of a LCD;

FIG. 2 illustrates the arrangement of three pixels (nine sub-pixels) of the LCD;

FIG. 3 illustrates the functioning of the LCD in a monochrome reflective mode;

FIG. 4 illustrates the functioning of the LCD in a color transmissive mode by using a partial color filtered approach;

FIG. 5 illustrates the functioning of the LCD in a color transmissive mode by using a hybrid field sequential approach;

FIG. 6 illustrates the functioning of the LCD in a color transmissive mode by using a diffractive approach; and

FIG. 7 illustrates an example configuration in which a multi-mode LCD runs at a low field rate without flicker.

FIG. 8A schematically illustrates structures of an example pixel according to an embodiment.

FIG. 8B schematically illustrates a second embodiment in which an auxiliary component is formed under a shaded line area.

### DETAILED DESCRIPTION

1. General Overview

In an embodiment, a multi-mode LCD as described hereinafter provides auxiliary functions that have not been possible to integrate into existing LCDs in the manner described herein.

In some embodiments, an LCD may comprise a plurality of pixels along a substantially planar surface, each pixel comprising a plurality of sub-pixels. A sub-pixel in the plurality of sub-pixels comprises a first polarizing layer with a first polarization axis and a second polarizing layer with a second polarization axis. The sub-pixel also comprises a first substrate layer and a second substrate layer opposite to the first substrate layer. The sub-pixel further may comprise a first reflective layer adjacent to the first substrate layer formed, for example, using a roughened metal contouring. In various embodiments other first layers need not be reflective. The first reflective layer may be made of roughened metal, comprising at least one opening that forms in part a transmissive part of the sub-pixel. The rest of the first reflective layer covered by the metal in the sub-pixel forms in part a reflective part of the sub-pixel. In some embodiments, a first filter of a first color is placed opposite to and covering the transmissive part with a larger area than an area of the transmissive part, while a second filter of a second color is placed opposite to and partially covering the reflective part. The second color is different from the first color.

The multi-mode LCD may further comprise a second reflector on one side of the first electrode layer, while the first reflective layer is on the opposite side of the first electrode layer. This second reflective layer may be made up of metal, comprising at least one opening that is a part of the transmissive part of the sub-pixel.

In an embodiment, the multi-mode LCD further comprises a light source for illuminating the multi-mode display. In various embodiments, the light source may be a backlight unit, ambient light, or front illumination. In some embodiments, a spectrum of color is generated from the light from the light source using a diffractive or a micro-optical film.

In an embodiment, color filters are disposed mainly over the transmissive part of a pixel and over a reflective portion as needed to achieve color in reflectance or management of the color of the perceived screen images. Separately, however, the techniques disclosed herein may be used with LCD implementations that lack color filters, such as LCDs with monochromatic (black/white or dark/light) transmissive performance or LCDs that use color generated from behind or from front illumination, such as by using field-sequential color.

In an embodiment, placing color filters (for example, the first filter of the first color) over the transmissive part of a pixel, and different color filters (for example, the second filter of the second color) over a portion of the reflective part of the pixel, enables shifting of the monochrome white-point and a strong readability in ambient light. In an embodiment, the black matrix mask used typically in color filter creation is eliminated. Additionally, an embodiment provides horizontally oriented sub-pixels to improve the resolution of the LCD in the color transmissive mode. Additionally, an embodiment provides vertically oriented sub-pixels to improve the resolution of the LCD in the color transmissive mode. Further, an embodiment enables the light to switch between two colors, while a third color (typically green) is always on, thereby decreasing the required frame rate of the LCD when used in the hybrid field sequential approach. In an embodiment, colors are created from the backlight, thereby eliminating the need for color filters. In an embodiment, color filters are used over only the green pixels, thereby eliminating the need for using additional masks for making the color filter array.

In an embodiment, the cross sectional area of the non-transmissive part of the sub-pixel may be over half of the total cross sectional area of the entire sub-pixel. For example, the reflective part may occupy 70% to 100% of the plurality of pixels. In an embodiment, in the multi-mode LCD, 1% to 50% of the reflective part in a sub-pixel is covered with one or more color filters.

For purposes of illustrating a clear example, the structure and use of particular forms of LCDs are now described. However, the techniques described herein at Section 6, in which various auxiliary functions are integrated into an LCD, may be implemented with LCDs having other particular structural forms.

In an embodiment, the transmissive part occupies an interior part of a cross section of the sub-pixel. In an embodiment, the first and second filters of different colors mentioned above may be configured to shift from a previous color tinged white point to a new monochrome colorless white point for the sub-pixel. In an embodiment, the transmissive part occupies 0% to 30% of the plurality of pixels. In an embodiment, the one or more color-filters are of different thicknesses. In an embodiment, the one or more color-filters are of a same thickness.

In an embodiment, the multi-mode LCD further comprises one or more colorless spacers placed over the reflective part. In an embodiment, the one or more colorless spacers are of a same thickness. In an embodiment, the one or more colorless spacers are of different thicknesses.

In an embodiment, the multi-mode LCD further comprises a driver circuit to provide pixel values to a plurality of switching elements, wherein the plurality of switching elements determines the light transmitting through the transmissive part. In an embodiment, the driver circuit further comprises a Transistor-Transistor-Logic interface. In an embodiment, the multi-mode LCD further comprises a timing control circuit to refresh the pixel values of the multi-mode Liquid Crystal Display.

In an embodiment, the multi-mode LCD as described herein forms a part of a computer, including but not limited to a laptop computer, notebook computer, e-book reader, cell phone, and netbook computer.

Various embodiments relate to a LCD that is capable of functioning in multi-mode, a monochrome reflective mode and a color transmissive mode. Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

2. Structural Overview

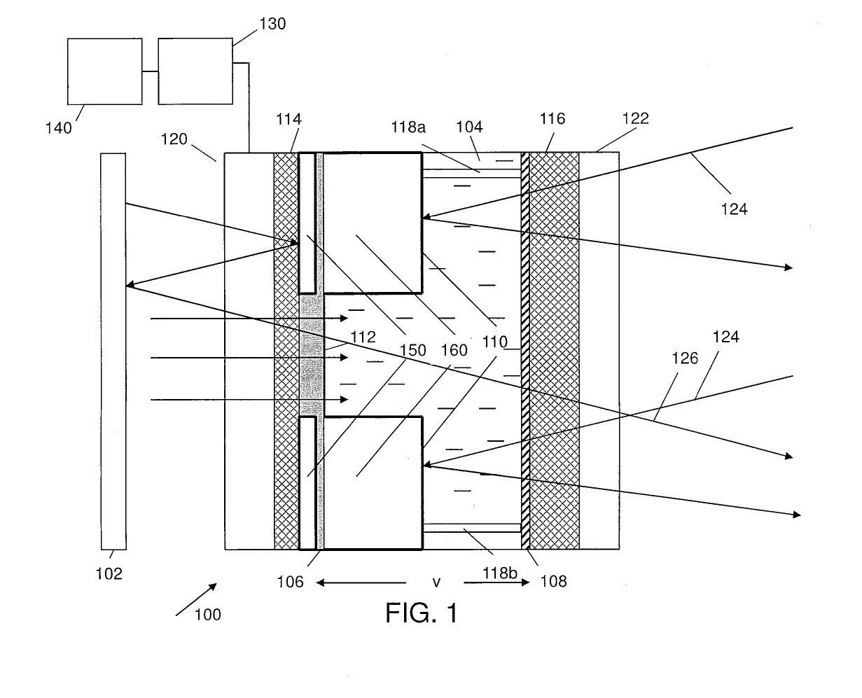

FIG. 1 is a schematic of a cross section of a sub-pixel 100 of a LCD. Sub-pixel 100 comprises a liquid crystal material 104, a sub-pixel electrode (or a first electrode layer) 106 that includes switching elements, a common electrode (or a second electrode layer) 108, a first reflective layer 160 that is located on one side of electrode 106, a second reflective layer 150 that is located on the other side of the electrode 106, a transmissive part 112, first and second substrate layers 114 and 116, spacers 118a and 118b, a first polarization layer 120, and a second polarization layer 122.

In an embodiment, first and second reflective layers 160 and 150 have an opening over the transmissive part 112. A surface of first reflective layer 160 forms in part a reflective part 110. A surface of second reflective layer 150 may be used to reflect light incident from the left-hand side of the surface. In an embodiment, a light source 102 or an ambient light 124 illuminates sub-pixel 100. Examples of light source 102 include, but are not limited to, Light Emitting Diodes backlights (LEDs), Cold-Cathode Fluorescent Lamps backlights (CCFLs), and the like. Ambient light 124 can be sunlight or any external source of light. In an embodiment, liquid crystal material 104, which is an optically active material, rotates the axis of the polarization of the light from light source 102 or ambient light 124. Liquid crystal 104 can be a Twisted Nematic (TN), an Electrically Controlled Birefringence (ECB) and the like. In an embodiment, the rotation of the polarization orientation of the light is determined by the potential difference applied between sub-pixel electrode 106, and common electrode 108. In an embodiment, sub-pixel electrode 106 and common electrode 108 can be made of Indium Tin Oxide (ITO). Further, each sub-pixel is provided with a sub-pixel electrode 106, while common electrode 108 is common to all the sub-pixels and pixels present in the LCD.

In an embodiment, reflective part 110 is electrically conductive and reflects ambient light 124 to illuminate sub-pixel 100. The first reflective layer 160 is made of metal and is electrically coupled to sub-pixel electrode 106 thereby providing the potential difference between reflective part 110 and common electrode 108. Transmissive part 112 transmits light from light source 102 to illuminate sub-pixel 100. Substrates 114 and 116 enclose liquid crystal material 104, pixel electrode 106 and common electrode 108. In an embodiment, sub-pixel electrode 106 is located at substrate 114, and common electrode 108 is located at substrate 116. Additionally, substrate 114 and sub pixel electrode layer comprises switching elements (not shown in FIG. 1). In an embodiment, the switching elements can be Thin Film Transistors (TFTs). In another embodiment the switching elements can be low temperature polysilicon.

A driver circuit 130 sends signals related to sub-pixel values to the switching elements. In an embodiment, driver circuit 130 uses low voltage differential signaling (LVDS) drivers. In another embodiment, a transistor-transistor logic (TTL) interface that senses both increase and decrease in voltages is used in driver circuit 130. Additionally, a timing controller 140 encodes the signals related to sub-pixel values into the signals needed by the diagonal transmissive parts of the sub-pixels. Furthermore, timing controller 140 has a memory to allow self-refresh of the LCD when the signals related to the sub-pixels are removed from timing controller 140.

In an embodiment, spacers 118a and 118b are placed over reflective part 110 to maintain a uniform distance between substrates 114 and 116. Additionally, sub-pixel 100 comprises first polarizer 120 and second polarizer 122. In an embodiment, the axes of polarity of first polarizer 120 and second polarizer 122 are perpendicular to each other. In another embodiment, the axes of polarity of first polarizer 120 and second polarizer 122 are parallel to each other.

Sub-pixel 100 is illuminated by light source 102 or ambient light 124. The intensity of light passing through sub-pixel 100 is determined by the potential difference between sub-pixel electrode 106, and common electrode 108. In an embodiment, liquid crystal material 104 is in a disoriented state and the light passing through first polarizer 120 is blocked by second polarizer 122 when no potential difference is applied between sub-pixel electrode 106, and common electrode 108. Liquid crystal material 104 is oriented when the potential difference is applied between sub-pixel electrode 106, and common electrode 108. The orientation of liquid crystal material 104 allows the light to pass through second polarizer 122.

In an embodiment, first reflective layer 160 is placed on one side of electrode 106, while second reflective layer 150 may be placed on the opposite side of electrode 106. The second reflective layer 150 may be made of metal, reflecting or bouncing light 126 (incident from the left-hand side of FIG. 1) one or more times until the light 126 transmits through the transmissive part 112 to illuminate sub-pixel 100.

For the purpose of illustrating a clear example, straight lines indicate light path segments of lights 112, 124, 126. Each of the light path segments may comprise additional bending due to diffractions which may occur when lights 112, 124, 126 travel through junctions between media of different refractive indexes.

For the purpose of illustrating a clear example, the sub-pixel 100 is illustrated with two spacers 118a and 118b. In various embodiments, two neighboring spacers may be placed one or more pixels apart, every ten pixels apart, every twenty pixels apart, every 100 pixels apart, or other distances apart.

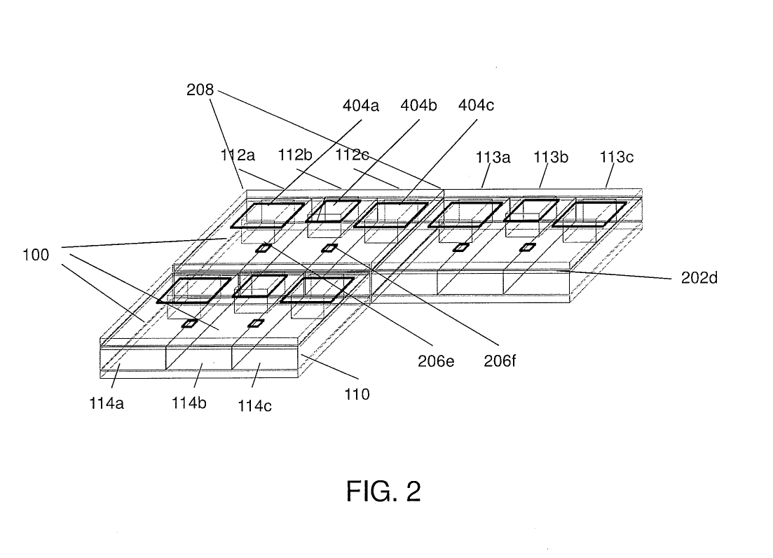

FIG. 2 illustrates the arrangement of nine sub-pixels 100 of the LCD. Sub-pixel 100 comprises transmissive part 112b and reflective part 110. In an embodiment, transmissive parts 112a-c impart red, green and blue color components respectively to form a color pixel, if the (Red-Green-Blue) RGB color system is followed. Additionally, transmissive parts 112a-c can impart different colors such as red, green, blue and white or other color combinations, if other color systems are chosen. Furthermore, transmissive part 113a and 114a impart red color, transmissive part 113b and 114b impart green color, and transmissive part 113c and 114c impart blue color to the color pixel. In some embodiments, color filters 404a-c of different thicknesses can be placed over transmissive parts 112a-c to decrease or increase the saturation of the color imparted to the color pixel. Saturation is defined as intensity of a specific gradation of color within the visible spectrum. Further, a colorless filter 202d can be placed over reflective part 110. In various embodiments, the thickness of colorless filter 202d can vary from zero to the thickness of color filters 404a-c placed over transmissive parts 112a-c.

In an embodiment, transmissive parts 112a represent a sub pixel of one of the three colors of the color pixel. Similarly, transmissive parts 112b and 112c represent sub-pixels of other two colors of the color pixel. In another embodiment, vertical oriented sub pixels can be used that increase the reflective and transflective resolution by three-fold in the horizontal direction when compared to the color transmissive operating mode. In another embodiment, horizontal stripes of sub pixels can be used that increase the reflective and transflective resolution by three-fold in the vertical direction when compared to the color transmissive mode.

The amount of light from light source 102 transmitting through each of the transmissive parts 112a-c is determined by the switching elements (not shown in FIG. 2). The amount of light transmitting through each transmissive parts 112a-c, in turn, determines the luminance of the color pixel. Further, the shape of transmissive parts 112a-c and the color filters 404a-c can be hexagonal, rectangular, octagonal, circular or so forth. Additionally, the shape of reflective part 110 can be rectangular, circular, octagonal, and the like.

In some embodiments, additional color filters may be placed over the reflective parts 110 of sub-pixels 100 in the pixel 208. These additional color filters may be used to provide compensating colors that help create a new monochrome white point for the sub-pixels in the pixel 208 in a monochromatic operating mode. With the new monochrome white point, the sub-pixels of the pixel 208 can be used to represent various shades of gray, collectively or individually.

For example, a color filter 206e may be used to cover an area of the reflective part 110 in the sub-pixel 100 that includes transmissive part 112a. In some embodiments as illustrated in FIG. 2, the color filter 206e may cover not only (1) a portion of the reflective part 110 in the sub-pixel 100 that contains the transmissive part 112a (which imparts the red color in the present example), but also (2) a portion of the reflective part 110 in the sub-pixel 100 that contains the transmissive part 112b (which imparts the green color in the present example). The color filter 206e may be used to impart the blue color in both the sub-pixels 100 that impart the red and green colors in the pixel 208.

Similarly, a color filter 206f may be used to cover an area of the reflective part 110 in the sub-pixel 100 that includes transmissive part 112c. In some embodiments as illustrated in FIG. 2, the color filter 206f may cover not only (1) a portion of the reflective part 110 in the sub-pixel 100 that contains the transmissive part 112c (which imparts the blue color in the present example), but also (2) another portion of the reflective part 110 in the sub-pixel 100 that contains the transmissive part 112b (which imparts the green color in the present example). The color filter 206f may be used to impart the red color in both the sub-pixels 100 that impart the blue and green colors in the pixel 208.

The reflective part of the red sub-pixel 100 has an area covered by the red color filter 404a and another area covered by the blue color filter 206e. The net result is that the red sub-pixel may receive red and blue color contributions from these areas covered by the color filters 404a and 206e. The same holds true for the blue sub-pixel. However, the reflective part of the green sub-pixel 100 has a first area covered by the green color filter 404b, a second area covered by the blue color filter 206e, and a third area covered by the red color filter 206f. In some embodiments, the first area may be smaller than either of the second and third areas or vice versa. In some embodiments, the second and third areas may be set to different sizes, in order to create a monochrome colorless white point. The net result is that the green sub-pixel may receive an overall red and blue color contribution from the color filters 404b, 206e and 206f that can compensate the green color contribution for the purpose of creating the monochrome colorless white point.

In some embodiments, as illustrated, these color filters 206e and 206f may cover only a portion of the reflective part 110 in a sub-pixel 100; most of the reflective part 110 in the sub-pixel 100 may be either covered by colorless filter 202d, or not covered by filters.

Embodiments may be configured for correcting other than green tinges. In various embodiments, the area covered by each of the color filters 404a-c may be the same as, or larger than, the area of the respective transmissive part 112a-c. For example, the color filter 404a that covers the transmissive part 112a may have an area larger than the area of the transmissive part 112a. The same may hold true for the color filters 404b and 404c. In these embodiments, the sizes of the color filters 404 and 206 may be placed or sized in certain ways to create a monochrome colorless white point.

In some embodiments, areas of sub-pixels 100 in the pixel 208 may or may not be the same. For example, the area of a green sub-pixel 100 that comprises the transmissive part 112b may be configured to be smaller than the areas of a red or blue sub-pixel 100 that comprises the transmissive part 112a or 112c).

In some embodiments, areas of color filters over transmissive parts 112a-c in the pixel 208 may or may not be the same. For example, the area of a green color filter 404b may be smaller than the areas of a red or blue color filter 404a, 404c.

In some embodiments, areas of color filters over the reflective part 110 in the pixel 208 may or may not be the same. For example, the area of the blue color filter 206e may be larger or smaller than the areas of the red color filter 206f.

In some embodiments, even though (1) the areas of sub-pixels 100 may be different, and/or (2) the areas covered by color filters 404a-c in the pixel 208 may be different, and/or (3) the areas covered color filters 206e and 206f in the pixel 208 may be different, reflective areas not covered by color filters in all the sub-pixels of the pixel 208 are substantially the same. As used herein, the term “substantially the same” refers to a difference within a small percentage. In some embodiments, reflective areas are substantially the same if the smallest and the largest of these reflective areas only differ within a specified range, for example, <=5%.

3. Functional Overview

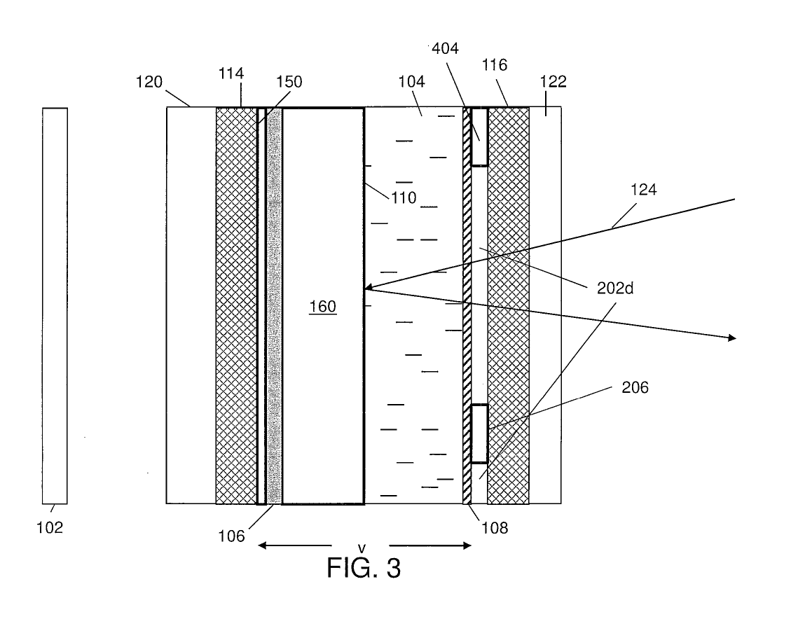

FIG. 3 illustrates the functioning of sub-pixel 100 (for example, any of the sub-pixels 100 in FIG. 2) in the monochrome reflective mode. Since the monochrome reflective embodiment is explained with reference to FIG. 3, only reflective part 110 is shown in the figure.

Sub-pixel 100 can be used in the monochrome reflective mode in the presence of an external source of light. In an embodiment, ambient light 124 passes through a layer of filters, and liquid crystal material 104 and is incident on reflective part 110. The layer of filters may comprise (1) colorless filter 202d, (2) color filter 404 (for example, 404a of FIG. 2 when the sub-pixel 100 is the one with the transmissive part 112a in FIG. 2) extending from the area opposite to the transmissive part of the sub-pixel 100 (for example, 112a of FIG. 2), and (3) color filter 206 (for example, 206e of FIG. 2). Any, some, or all, of the filters may be used to maintain the attenuation and the path difference of ambient light 124 the same as the attenuation and the path difference of the light in the color transmissive mode. The colorless color filter 202d can also be omitted by modifying the design.

Reflective part 110 of sub-pixel 100 reflects ambient light 124 to substrate 116. In an embodiment, a potential difference (v) is applied to sub-pixel electrode 106, which is electronically coupled to the reflective part 110 and common electrode 108. Liquid crystal material 104 is oriented, depending on the potential difference (v). Consequently, the orientation of liquid crystal material 104 rotates the plane of ambient light 124, allowing the light to pass through second polarizer 122. The degree of orientation of liquid crystal material 104 therefore determines the brightness of sub-pixel 100 and consequently, the luminance of sub-pixel 100.

In an embodiment, a normally white liquid crystal embodiment can be employed in sub-pixel 100. In this embodiment, axes of first polarizer 120 and second polarizer 122 are parallel to each other. The maximum threshold voltage is applied across sub-pixel electrode 106, and common electrode 108 to block the light reflected by reflective part 110. Sub-pixel 100 therefore appears black. Alternatively, a normally black liquid crystal embodiment can be used. In this embodiment, axes of first polarizer 120 and second polarizer 122 are perpendicular to each other. The maximum threshold voltage is applied across sub-pixel electrode 106, and common electrode 108 to illuminate sub-pixel 100.

For the purpose of illustrating a clear example, the reflective part 110 is shown as a smooth straight line. Alternatively, the reflective part 110 may have a roughened or bumpy surface at the micron level or sub-micron levels.

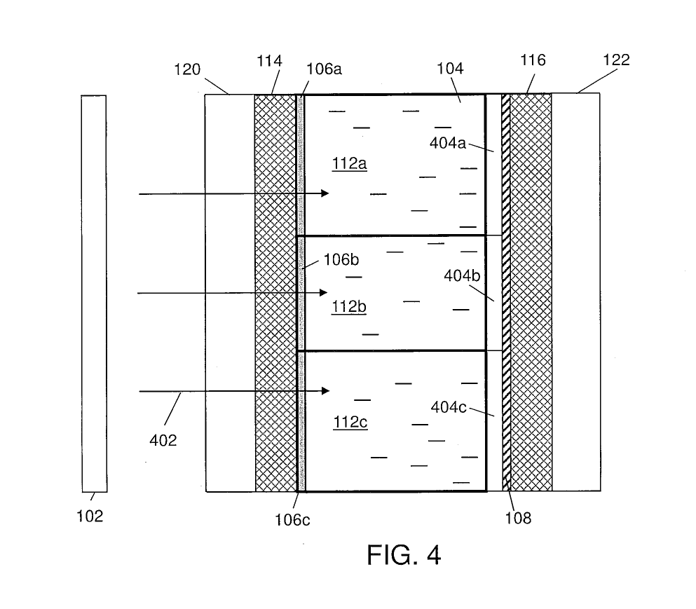

FIG. 4 illustrates the functioning of the LCD in the color transmissive mode by using a partial color filtered approach. Since the color transmissive embodiment is being explained, only transmissive parts of the sub-pixel: 112a-c are shown in FIG. 4. On substrate 116, color filters 404a, 404b and 404c are respectively placed in transmissive sub-pixel parts 112a, 112b and 112c, as shown in FIG. 4. Sub-pixel parts 112a, 112b and 112c refer to the sub-pixel optical value. Part 112a has optical contributions from part 102, 402, 120, 114, 106a, 104, 404a 108, 116 and 122. Part 112b has optical contributions from part 102, 402, 120, 114, 106b, 104, 404b, 108, 116, and 122. Part 112c has optical contributions from part 102, 402. 120, 114, 106c, 104, 404c, 108, 116, and 122. Color filters 404a, 404b, and 404c are also spread partially over (or extending out to a part of) the reflective area of the sub-pixel. In various embodiments, the color filters cover any amount that is less than half the reflective area of the pixel (for example, 0% to 50% of the area) and in one particular embodiment the color filters cover about 0% of the area, and in another particular embodiment they cover 6% to 10% of the area, and in yet another particular embodiment they cover 14% to 15% of the area.

Light source 102 is a backlight source producing light 402 that can be collimated by using a collimating light guide or lens. In an embodiment, light 402, coming from light source 102, is passed through first polarizer 120. This aligns the plane of light 402 in a particular plane. In an embodiment, the plane of light 402 is aligned in the horizontal direction. Additionally, second polarizer 122 has an axis of polarization in the vertical direction. Transmissive parts 112a-c transmit light 402. In an embodiment, each of transmissive parts 112a-c has an individual switching element. The switching element controls the intensity of light 402 passing through the corresponding transmissive part.

Further, light 402, after transmitting through transmissive parts 112a-c, passes through liquid crystal material 104. Transmissive parts 112a, 112b, and 112c are provided with sub-pixel electrodes 106a-c respectively. The potential differences applied between sub-pixel electrode 106a-c, and common electrode 108 determine the orientation of liquid crystal material 104. The orientation of liquid crystal material 104, in turn, determines the intensity of light 402 incident on each color filter 404a-c.

In an embodiment, a green color filter 404a is placed mostly or completely over transmissive part 112a and may also be placed partially the reflective portion 110 (shown in FIGS. 2 and 3), a blue color filter 404b is placed mostly or completely over transmissive part 112b and may also be placed partially over the reflective portion 110 (shown in FIGS. 2 and 3) and a red color filter 404c is placed mostly or completely over transmissive part 112c and may also be partially over the reflective part 110 (shown in FIGS. 2 and 3). Each of color filters 404a-c imparts the corresponding color to the color pixel. The colors imparted by color filters 404a-c determine the chrominance value of the color pixel. Chrominance contains the color information such as hue and saturation for a pixel. Further, if there is ambient light 124, the light reflected by reflective part 110 (shown in FIGS. 2 and 3) provides luminance to the color pixel and imparts a monochrome adjustment to the white reflectance of the pixel which can compensate for the greenish look of the LC mode. This luminance therefore increases the resolution in the color transmissive mode. Luminance is a measure of the brightness of a pixel.

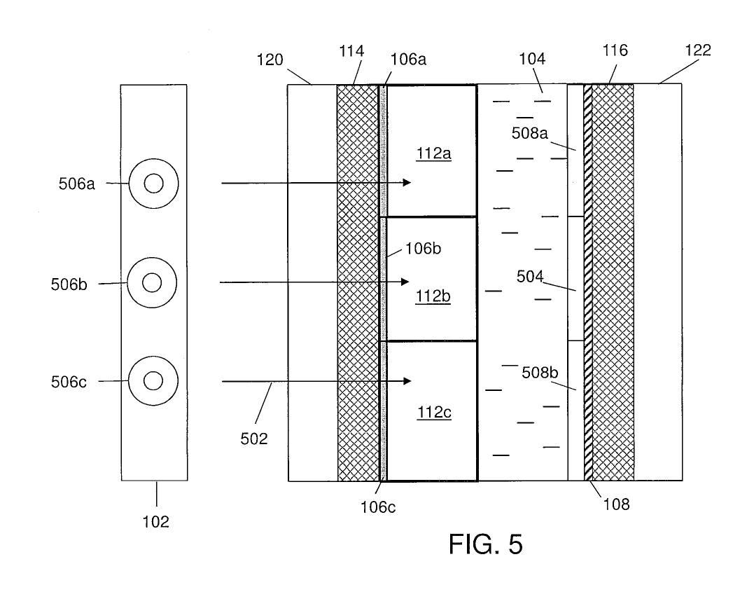

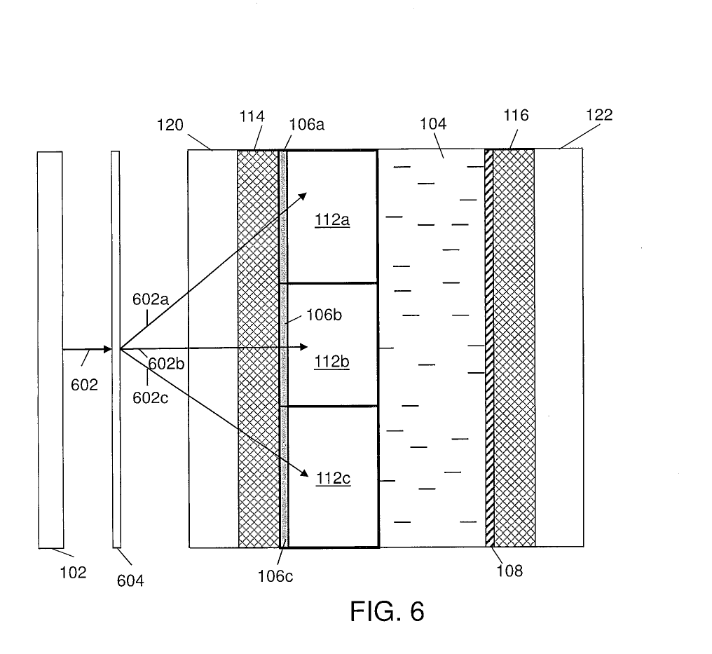

As illustrated in FIG. 4, the transmissive parts 112a-c may have different cross sectional areas (which normal directions are the horizontal direction in FIG. 4). For example, the green transmissive part 112b may have a smaller area than those of the red and blue transmissive part 112a and 112c, as the green light may transmit more efficiently in the sub-pixel 100 than the lights of other colors. The cross sectional areas for transmissive parts 112a-c as illustrated in FIG. 4 here, and FIG. 5 and FIG. 6 below, may or may not be different in various embodiments.

FIG. 5 illustrates the functioning of the LCD in the color transmissive mode by using a hybrid field sequential approach, in accordance with various embodiments. Since the color transmissive embodiment is being explained, only transmissive parts 112a-c are shown in FIG. 5. In an embodiment, light source 102 comprises strips of LEDs such as LED group 1, LED group 2 and so on (not shown). In an embodiment, the LEDs that are arranged horizontally are grouped together, one LED group below the other, to illuminate the LCD. Alternatively, the LEDs that are arranged vertically can be grouped.

The LEDs groups are illuminated in a sequential manner. The frequency of illumination of an LED group can be between 30 frames to 540 frames per second. In an embodiment, each LED group comprises red LEDs 506a, white LEDs 506b and blue LEDs 506c. Further, red LEDs 506a and white LEDs 506b of LED group 1 are on from time t=0 to t=5 and red LEDs 506a and white LEDs 506b of LED group 2 are on from time t=1 to t=6. Similarly, all the red and white LEDs of other LED groups function in a sequential manner. In an embodiment, each LED group illuminates a horizontal row of pixels of the LCD, in case the LED groups are arranged vertically. Similarly blue LEDs 506c and white LEDs 506b of LED group 1 are on from time t=5 to t=10, and blue LEDs 506c and white LEDs 506b of LED group 2 are on from time t=6 to t=11. Similarly, all the blue and white LEDs of other LED groups are on in a sequential manner. Red LEDs 506a, white LEDs 506b and blue LEDs 506b are arranged so that red LEDs 506a and blue LEDs 506b illuminate transmissive parts 112a and 112c and white LEDs 506b illuminate transmissive part 112b. In another embodiment, the LED groups may comprise red, green and blue LEDs. Red, green and blue LEDs are so arranged that green LEDs illuminate transmissive part 112b and red and blue LEDs illuminate transmissive parts 112a and 112c, respectively.

In an embodiment, light 502 from light source 102 is passed through first polarizer 120. First polarizer 120 aligns the plane of light 502 in a particular plane. In an embodiment, the plane of light 502 is aligned in a horizontal direction. Additionally, second polarizer 122 has the axis of polarization in the vertical direction. Transmissive parts 112a-c transmit light 502. In an embodiment, each of transmissive parts 112a-c has an individual switching element. Further, switching elements control the intensity of light passing through each of transmissive parts 112a-c, thereby controlling the intensity of the color component. Further, light 502, after passing through transmissive parts 112a-c, passes through liquid crystal material 104. Each of transmissive parts 112a-c has its own sub-pixel electrode 106a-c respectively. The potential differences applied between sub-pixel electrodes 106a-c, and common electrode 108 determines the orientation of liquid crystal material 104. In the embodiment in which red, white, and blue LEDs are used, the orientation of liquid crystal material 104, in turn, determines the intensity of light 502 incident on a green color filter 504, and transparent spacers 508a and 508b.

The intensity of light 502 passing though green filter 504, and transparent spacers 508a and 508b determines the chrominance value of the color pixel. In an embodiment, green color filter 504, is placed corresponding to transmissive part 112b. Transmissive part 112a and 112c do not have a color filter. Alternatively, transmissive parts 112a and 112c can use transparent spacers 508a and 508b respectively. Green color filter 504, transparent spacers 508a and 508b are located on substrate 116. In another embodiment, magenta color filters can be placed over transparent spacers 508a and 508b. In an embodiment, during time t=0 to t=5, when red LED 506a and white LED 506b are on, transmissive parts 112a and 112c are red and green filter 504 imparts a green color to transmissive part 112b. Similarly, during time t=6 to t=11, when blue LED 506c and white LEDs 506b are on, transmissive parts 112a and 112c are blue, and green filter 504 imparts a green color to transmissive part 112b. The color imparted to the color pixel is formed by the combination of colors from transmissive parts 112a-c. Further, if ambient light 124 is available, the light reflected by reflective part 110 (shown in FIG. 2 and FIG. 3) provides luminance to the color pixel. This luminance therefore increases the resolution in the color transmissive mode.

FIG. 6 illustrates the functioning of the LCD in the color transmissive mode by using a diffractive approach. Since the color transmissive embodiment is being explained, only transmissive parts 112a-c are shown in FIG. 6. Light source 102 can be a standard backlight source. In an embodiment, light 602 from light source 102 is split into a green component 602a, a blue component 602b and a red component 602c by using a diffraction grating 604. Alternatively, light 602 can be split into a spectrum of colors with a different part of the spectrum going through each of transmissive parts 112a-c using a micro-optical structure. In an embodiment, the micro-optical structure is a flat film optical structure with small lensets that can be stamped or imparted into the film. Green component 602a, blue component 602b and red component 602c are directed to transmissive parts 112a, 112b and 112c, respectively, using diffraction grating 604.

Further, the components of light 602 are passed through first polarizer 120. This aligns the plane of light components 602a-c in a particular plane. In an embodiment, the plane of light components 602a-c is aligned in the horizontal direction. Additionally, second polarizer 122 has its axis of polarization in the vertical direction. Transmissive parts 112a-c allow light components 602a-c to be transmitted through them. In an embodiment, each of transmissive parts 112a-c has an individual switching element. Switching elements control the intensity of light passing through each of transmissive parts 112a-c, thereby controlling the intensity of the color component. Further, light components 602a-c, after passing through transmissive parts 112a-c, passes through liquid crystal material 104. Transmissive parts 112a, 112b and 112c respectively have pixel electrodes 106a, 106b and 106c. The potential differences applied between pixel electrodes 106a-c, and common electrode 108 determines the orientation of liquid crystal material 104. The orientation of liquid crystal material 104, in turn, determines the intensity of light components 602a-c passing through second polarizer 122. The intensity of color components passing through second polarizer 122 in turn decides the chrominance of the color pixel. Further, if ambient light is available, the light reflected by reflective part 110 (shown in FIG. 2 and FIG. 3) provides luminance to the color pixel. This luminance therefore increases the resolution in the color transmissive mode.

As presented herein, the presence of ambient light enhances the luminance of the color pixel in the color transmissive mode. Therefore, each pixel has both luminance and chrominance. This increases the resolution of the LCD. Consequently, the number of pixels required for a particular resolution is lower than in prior known LCDs, thereby decreasing the power consumption of the LCD. Further, a Transistor-Transistor Logic (TTL) based interface can be used that lowers the power consumption of the LCD as compared to the power consumed by the interfaces used in prior known LCDs. Additionally, because the timing controller stores the signals related to pixel values, the LCD is optimized for using the self refresh property, thereby decreasing the power consumption. In various embodiments, thinner color filters which transmit less saturated color and more light can be used. Hence, various embodiments facilitate the process of reducing the power consumption, as compared to prior known LCDs.

Further, in an embodiment (described in FIG. 5), green or white color light is always visible on sub-pixel 100, and only the red and blue color lights are switched. Therefore, a lower frame rate may be used as compared to the frame rate of prior known field sequential displays.

4. Driving Signal Techniques

In some embodiments, a pixel in a multi-mode LCD as described herein can be used in the color transmissive mode in the same manner as a standard color pixel. For example, three sub-pixels in the pixel 208 (FIG. 2) of the multi-mode LCD can be electronically driven by a multi-bit signal representing a RGB value (for example, a 24-bit signal) to produce the specified red, green, and blue component colors in the pixel.

In some embodiments, a pixel in a multi-mode LCD as described herein can be used as a black-and-white pixel in a black-and-white reflective mode. In some embodiments, three sub-pixels in a pixel of the multi-mode LCD can be individually, or alternatively collectively, electronically driven by a single 1-bit signal to produce either black or white in the sub-pixels. In some embodiments, each of the sub-pixels in a pixel of the multi-mode LCD can be individually electronically driven by a different 1-bit signal to produce either black or white in each sub-pixel. In these embodiments, power consumption is drastically reduced by (1) using 1-bit signals as compared with the multi-bit signals in the color transmissive mode and/or (2) using ambient light as a main source of the light. In addition, in the black-and-white reflective modes where each sub-pixel can be individually driven by a different bit value and each sub-pixel is an independent unit of display, the resolution of the LCD in these operating modes can be made as high as three times the resolution of the LCD operating in other modes in which a pixel is used as an independent unit of display.

In some embodiments, a pixel in a multi-mode LCD as described herein can be used as a gray pixel (for example, in a 2-bit-, 4-bit-, or 6-bit-gray-level reflective mode). In some embodiments, three sub-pixels in a pixel of the multi-mode LCD can be collectively electronically driven by a single multi-bit signal to produce a shade of gray in the pixel. In some embodiments, each of the sub-pixels in a pixel of the multi-mode LCD can be individually electronically driven by a different multi-bit signal to produce a shade of gray in each sub-pixel. Similar to the black-and-white operating mode, in these embodiments of different gray-level reflective modes, power consumption may be drastically reduced by (1) using signals of a lower number of bits as compared with the multi-bit signals in the color transmissive mode and/or (2) using ambient light as a main source of the light. In addition, in the gray-level operating modes where each sub-pixel can be individually driven by a different bit value and each sub-pixel is an independent unit of display, the resolution of the LCD in these operating modes can be made as high as three times the resolution of the LCD in other operating modes in which a pixel is used as an independent unit of display.

In some embodiments, a signal may be encoded into the video signal that instructs a display driver what operating mode and what corresponding resolution to drive. A separate line may be used to inform the display to go into a low-power mode.

5. Low Field Rate Operations

In some embodiments, a low field rate may be used to reduce power consumption. In some embodiments, the driver IC for the multi-mode LCD may run with a slow liquid crystal and may comprise electronics that allow the electric charge to be held longer at a pixel. In some embodiments, metal layers 110, 150 of FIG. 1 and electrode layer 106 (which may be an oxide layer) may operate as additional capacitors to hold the electric charge.

In some embodiments, a layer of liquid crystal material 104 having a high value of Δn, termed a high birefringence LC material, may be used. For example, LC material with Δn=0.25 may be used. Such a high birefringence liquid crystal with high resistivity may switch states with a low field rate, and may have a high voltage holding ratio and long life even at the slow switching frequency. In one embodiment, the 5CB liquid crystal material commercially available from Merck may be used.

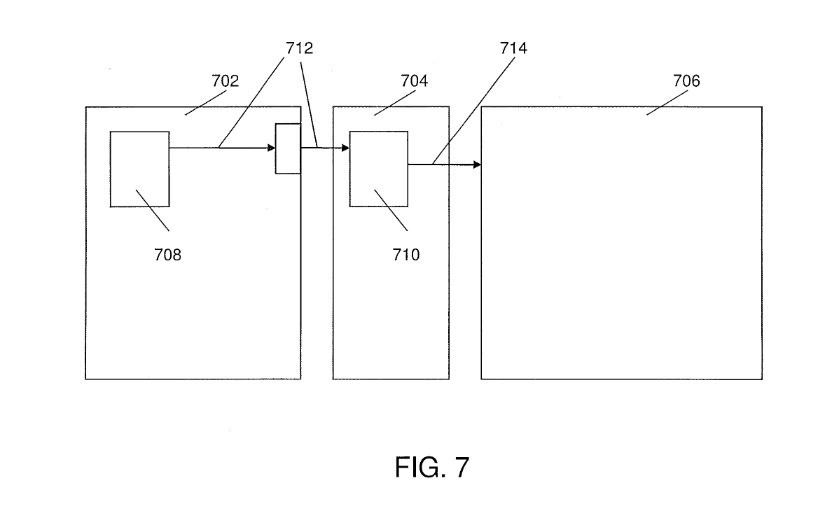

FIG. 7 illustrates an example configuration in which a multi-mode LCD (706) runs at a low field rate without flicker. A chipset 702 that contains a CPU (or a controller) 708 may output a first timing control signal 712 to timing control logic 710 in a LCD driver IC 704. The timing control logic 710 in turn may output a second timing control signal 704 to the multi-mode LCD 706. In some embodiments, the chipset 702 may, but is not limited to, be a standard chipset that can be used to drive different types of LCD displays including the multi-mode LCD 706 as described herein.

In some embodiments, the driver IC 704 is interposed between the chipset 702 and the multi-mode LCD 706, and may contain specific logic to drive the multi-mode LCD in different operating modes. The first timing control signal 712 may have a first frequency such as 30 hz, while the second timing control signal 714 may have a second frequency in relation to the first frequency in a given operating mode of the multi-mode LCD. In some embodiments, the second frequency may be configured or controlled to be one half of the first frequency in the reflective mode. As a result, the second timing control signal 714 received by the multi-mode display 706 may be a smaller frequency than that for a standard LCD display in that mode. In some embodiments, the second frequency is regulated by the timing control logic 710 to have different relationships with the first frequency depending on the operating modes of the multi-mode LCD 706. For example, in the color transmissive mode, the second frequency may be the same as the first frequency.

In some embodiments, a pixel such as pixel 208 of FIG. 2 may be formed substantially as a square while the sub-pixels 100 may be formed as rectangles that are arranged such that the short sides of the rectangles are adjacent. In these embodiments, a sub-pixel 100 is said to be oriented in the direction of the long side of its rectangle form. In some embodiments, the multi-mode LCD is substantially in the form of a rectangle. The sub-pixels in the LCD may be oriented along the long side of the LCD rectangle or the short side of the LCD rectangle.

For example, if the multi-mode LCD is used mainly for e-reader applications, then the multi-mode LCD may be used in the portrait mode with the long side in the vertical (or up) direction. The sub-pixels 100 may be configured to orient in the long side direction of the multi-mode display. On the other hand, if the multi-mode LCD is used for various different applications such as video, reading, internet, and game, then the multi-mode LCD may be used in the landscape mode with the long side in the horizontal direction. The sub-pixels 100 may be configured to orient in the short side direction of the multi-mode display. Thus, the orientation of the sub-pixels in the multi-mode LCD display may be set in such a way as to enhance the readability and resolution of the contents in its main uses.

6. Auxiliary Components

In an embodiment the disclosure provides techniques to use available areas in the pixels for auxiliary or additional electrical, optical, photodiode and photovoltaic (PV) sensors or components without the sacrifice of the optical performance of the LCD panel. The available area may be any part of a sub pixel other than the transmissive part. The available area may comprise, in various embodiments, an area under a reflective part of a pixel and/or an area under the source and gate conductive lines between pixel structures, and in these embodiments the auxiliary components may replace or supplement capacitors or other structures that have been formed in the same area in previous typical LCD panels. In certain embodiments, the source and gate conductive lines may be made wider or use different materials than in typical LCD panels, to address lower power, better speed and other issues, and auxiliary components may be implemented in the space under the wider line areas.

Embodiments are applicable to any transflective LCD that has a relatively large non-transmissive part in each pixel. In one embodiment, a memory-in-pixel function is added to reduce power consumption of the LCD and to result in extending battery life. In another embodiment, high refresh rate logic and one or more driver circuits, such as overdrive circuits or undershoot driver circuits, are provided in the available area to make good use of amorphous silicon technology and further improve the optical performance of LCDs. Embodiments help overcome physical limitations of amorphous silicon technology by providing additional driver circuitry or driving lines to facilitate better performance in large screen video monitors, for example. Embodiments also provide ways for an LCD screen to effectively look outward by collecting light or sensing conditions of the ambient environment and using sensed light, data values or other information in new ways. In all such cases, the transmissive part of the LCD is unaffected.

In another embodiment, a touch function is implemented in the non-transmissive area of the pixels to provide a better human-machine interface. In another embodiment, one or more light sensors are provided in the non-transmissive area of pixels to detect ambient light. Signals from the light sensors may be used to tune the BLU intensity, change the LCD to a pure reflective mode, or change the corresponding gamma curve to provide an optimal reading experience.

In another embodiment, the non-transmissive area of pixels comprises a series of CMOS-like photodiodes for image scanning above the M1 area. This embodiment may be used to implement a camera, for example, such as a web cam or other relatively lower resolution camera applications.

In another embodiment, the photodiodes may be used to implement eye tracking so that a computer or other logic coupled to the LCD can track movement of one or both eyes of a user of the LCD panel and, in response, display different images or take other responsive actions based on a determination of the part of the display that the user is viewing or focused upon. In one implementation, infrared light that emanates from the screen is reflected back toward the screen by the eyeballs of a viewer or viewers. The infrared light may be obtained from an infrared component in the backlight, or for example via an infrared component of a front light, or another source of infrared light that is co-located with the screen. Photodiodes are provided that are sensitive to the infrared light that is reflected back toward the screen from the eyes of the viewer(s).

In another embodiment, the non-transmissive area of pixels comprises photovoltaic solar cells or other light absorbing areas that are configured to transfer incident ambient light or BLU light into electric power using photovoltaic activity. For example, the device battery may be charged using sun power that has been converted to electricity using photovoltaic cells.

In an embodiment, the non-transmissive area of the pixels comprises organic LED (OLED) structures that enable the LCD to comprise a four-mode transflective LCD, and which can improve the color performance in both the transmissive and reflective mode.

In any of the embodiments, manufacturing costs may be reduced by using low cost element materials such as opaque aluminum rather than costly ITO or rare metals. The functions of various embodiments can be realized in a transflective LCD or a pure transmissive LCD. The pixel structures provided herein can provide a transmissive mode with high optical performance. The non-transmissive part may comprise a non-transparent, opaque or less-reflective part, or a large portion of metallic elements in the TFT circuit and drivers.

Various embodiments may use various LC modes, layout design, mode switching and driving, backlight recirculation, BLU design, and other structures and circuits to provide good color in transmissive and transflective mode, and a low power consumption black-white reflective mode. In some approaches, a large size reflective part can be used due to the backlight recirculation properties of the pixel structures, to achieve optical performance in transmissive mode that is as high as a conventional transmissive LCD; typically no black masks are needed for large aperture ratio and high reflectance displays. Typically, a large M1 is also used to facilitate backlight recirculation and light shielding from the gate and source lines.

Embodiments provide ways to add auxiliary or additional electrical, optical and photovoltaic components without sacrificing the performance of an LCD.

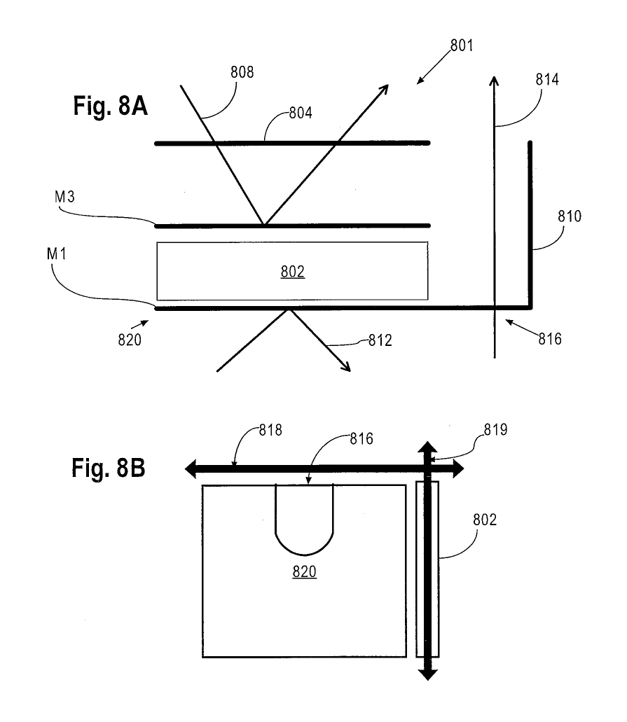

FIG. 8A schematically illustrates structures of an example pixel according to an embodiment. Pixel 801 generally comprises upper layer 804, intermediate metal layer M3, base metal layer M1, and side structure 810. Layers M1, M3 are opaque whereas layer 804 is transparent or translucent. Layers M1, M3 may be reflective. The top of the view represents a top or viewing side of a screen and the bottom of the view of FIG. 8 represents a location of a backlight and other circuitry.

In this arrangement ambient light rays 808 entering the pixel are reflected off of layer M3 and return to the viewer as reflected light, facilitating a reflective mode. Thus layer M3 essentially defines an area of a reflective part of the pixel 801. Certain backlight rays 812 strike layer 812 and are re-circulated as additional backlight. Other backlight rays 814 leave the transmissive part of the pixel and reach the viewer of an LCD panel containing the pixel.

An auxiliary component 802 is formed between layers M1, M3. In various embodiments, auxiliary component 802 comprises one or more electrical circuit structures, optical structures, or photovoltaic structures. Since auxiliary component 802 is arranged in a non-transmissive area of a pixel and thus in a non-transmissive area of an LCD screen comprising numerous pixels, the overall optical performance of the transflective LCD is unaffected, especially in the transmissive part.

FIG. 8B schematically illustrates a second embodiment in which an auxiliary component is formed under a shaded line area. In an embodiment, a pixel 801 of a transflective LCD comprises a relatively larger reflective area 820 and a relatively smaller transmissive area 816. One or more gate driver lines 818 and source driver lines 819 are formed near the pixel 801 and are typically arranged in a rectilinear matrix in interstices between a large plurality of pixels forming a pixel array of an LCD panel or screen.

In an embodiment, the lines 818, 819 are formed in sizes that are wider or larger than typical practice and the auxiliary component 802 is formed in a light shaded area under one or more of the lines. For example, FIG. 8B shows auxiliary component 802 under line 819 but in another embodiment the component 802 may be formed under line 818. For purposes of illustrating a clear example, auxiliary component 802 is shown in elongated form to occupy substantially all of a portion of line 819 that is adjacent to a side of pixel 801. However, in an embodiment, the auxiliary component 802 may be formed under any portion or part, or multiple portions or parts, of line 818 or line 819.

In still another embodiment, the auxiliary component 802 may be formed in a purely transmissive LCD panel by locating the auxiliary component in areas of the pixel that are opaque or black, and that are not used for reflective parts as in a transflective display. In such an embodiment, a particular percentage or area of a sub-pixel may be set aside for use for any of the auxiliary components that are described in subsequent sections herein.

6.1—Memory in Pixel Structures

In an embodiment, auxiliary component 802 comprises one or more digital electronic transistors, gates, drivers or other active circuitry forming a memory cell within the pixel 801. Thus, in one embodiment, pixel 801 implements “memory in pixel.” In a specific configuration, the memory in pixel auxiliary logic or drivers are typically prepared unto or above the shaded gate and source lines during the conventional TFT preparation process, or occupy some portion of the reflective part.

Various kinds of data may be stored in the memory structure at a pixel. Typically the memory stores data values that are to be displayed at a particular pixel so that the memory-in-pixel locally stores what the pixel is displaying. The memory in pixel auxiliary driver is typically driven at a low frequency from a dozens of hertz to only a few hertz. The memory in pixel can support a low refresh rate screen update function and a local pixel self-refresh function. Thus, in one embodiment, the memory in pixel structures are configured to locally rewrite changed content into a pixel during frame to frame refreshing, which can reduce the power consumption of the LCD because changed content may be rewritten locally and only at a particular pixel that has changed, and without a driver circuit having to rewrite the entire display. It is known, for example, that driver circuits, graphics chips and the like are significant consumers of power within a computer system and therefore the approaches herein can significantly reduce power consumption of a system as a whole.

Further, embodiments reduce the need to tune the voltage holding ratio of a conventional panel driver circuit to account for decay in the voltage stored at different pixels. This approach is also beneficial for a TR-LCD configured as an e-paper display or configured as an e-reader display. For example, displays that show relatively stable images can benefit from an approach such as that herein in which data is stored locally at pixels and refreshed locally, rather than requiring the entire pixel array of a generally stable image to be refreshed at a high rate when a relatively small number of pixels have actually changed. Refreshing a pixel may be triggered when logic or circuitry local to a pixel detects that a new value has been loaded into the local memory cell of that pixel.

6.2—High Refresh Rate Logic and Driver

Large LCD panels such as those used in large format televisions are typically manufactured using long gate and source driver lines, which reduce the overall refresh rate of the panel which may have a negative impact in the display of fast-changing video or other television images. In an embodiment, auxiliary component 802 comprises a high refresh rate logic driver circuit within a pixel or sub-pixel. In a first specific configuration, the high refresh rate logic is prepared under the shaded gate and source lines during TFT preparation of a pixel as in the arrangement of FIG. 8B. This embodiment uses the expanded space used for row and column lines in a TR-LCD of the type shown herein. The row and column lines can be wider, providing more conductive material that can convey flows of electrons to pixels; the lines also can have greater separation from other lines to reduce parasitic effects. Alternatively, the logic occupies some portion of the reflective part of a pixel as shown in FIG. 8A. These areas provide space for additional transistors or other driver logic that may be particularly useful in high refresh applications such as large panel televisions.

The high refresh rate logic can be configured as a frequency multiplexer which can provide a high frequency such as 120 Hz, 240 Hz or other frequency to address the corresponding LC mode instead of the standard 60 Hz frequency. The use of a high refresh rate for an LCD panel containing pixels as disclosed herein may permit improved display performance for video and other rapidly changing data. Embodiments are expected to achieve, in an amorphous silicon LCD panel, some of the performance attributes that otherwise are achievable only using low-temperature polysilicon (LTPS) panels. Because of this performance improvement, embodiments are also applicable to devices with very high pixel densities that are challenging the performance limits of amorphous silicon, such as displays for mobile phones, smartphones, handled pad-type computers and the like.

In an embodiment, overdrive/undershoot driver logic is configured under the shaded gate and source lines during the TFT preparation of a pixel array for an LCD panel, as in the arrangement of FIG. 8B, or occupies a portion of the reflective part of a pixel as shown in FIG. 8A. The overdrive/undershoot driver logic is configured to shorten the response time of the LC material, which may be helpful to show vivid and high-definition multi-media data.

In the above configurations, since the auxiliary logic is in a non-transmissive area of the LCD screen, the optical performance of the TR-LCD, especially in the transmissive part, will not be affected.

6.3—Touch Sensor—External or Embedded

In an embodiment, the auxiliary component 802 may support touch-sensitive functions for an LCD panel that is structured as shown in FIG. 8A, FIG. 8B. In a first specific configuration, a cover sheet with touch panel function is attached outside of the LCD panel, for example, above layer 804 of FIG. 8A. In one embodiment, the touch sensor and circuit lines for a corresponding controller are arranged along the shaded gate and source lines of the LCD panel in the position of auxiliary component 802 as seen in FIG. 8B. Alternatively, the touch sensor and circuit lines for the controller are configured to occupy some portion of the reflective part as seen for auxiliary component 802 of FIG. 8A.

These embodiments will not reduce the active area of a pixel in a pure transmissive LCD, and also provide a good-sized transmissive part without sacrificing brightness in a TR-LCD. For example, conventional touch screens typically involve placing a touch-sensitive layer over an LCD, but the layer greatly reduces the amount of light that reaches reflective parts of pixels and also blocks a portion of light emitted from the transmissive parts of the pixels. Further, another disadvantage of conventional touch screen panels is that multiple different manufacturing steps, often performed at multiple different specialty manufacturers, are needed to create the LCD panel, create the touch panel, and laminate the panels together. The present arrangement overcomes these issues by integrating touch sensitivity into the pixel and increases the value created by a single factory, and should provide lower cost by taking advantage of factory integration. The touch panel can be a resistive type, capacitive type, or other electrical and optical touch panel.

6.4—Embedded Light Sensor

In an embodiment, auxiliary component 802 may comprise one or more light sensors that are embedded in pixels of an LCD panel in the arrangement of either FIG. 8A or FIG. 8B. In a specific configuration, one or more light sensors are arranged and embedded below the shaded gate and source lines as shown for auxiliary component 802 in FIG. 8B. Alternatively, one or more light sensors occupy some portion of the reflective part as shown for auxiliary component 802 of FIG. 8A.

In these arrangements, the embedded light sensors are configured to detect attributes of ambient light, such as the intensity and incident light type of ambient light. Additionally or alternatively, embedded light sensors may be configured to determine the type of light source such as whether ambient light is sunlight, fluorescent light or similar.

Additionally or alternatively, data obtained from the embedded light sensors may be used, with appropriate digital control logic or external software, to modify or tune the BLU intensity of specified pixels or the LCD panel as a whole. Additionally or alternatively, data obtained from the embedded light sensors may be used, with appropriate digital control logic or external software, to change the operation of the LCD panel into a pure reflective mode or to cause changing the corresponding gamma curve to get the optimal reading experience.

6.5—Photodiode for Image Scanning

In an embodiment, auxiliary component 802 may comprise one or more photodiodes that may be coupled to control logic or driver logic, within the auxiliary component 802 or in external locations, and which may be coupled to externally hosted software or firmware, configured to implement image scanning functions.

In a specific configuration, a series of photodiodes such as CMOS type photodiodes are embedded under the shaded gate and source lines as seen in FIG. 8B for the position of auxiliary component 802. Alternatively, auxiliary component 802 comprises photodiodes that occupy some portion of the reflective part of a pixel as seen in FIG. 8A. In these arrangements and with appropriate control logic, driver logic, and/or software or firmware, the photodiodes can be configured to scan images received above the LCD panel, and to transfer the images to a printer, storage device, output port, or other external system or device. Since the photodiodes are specifically arranged in the non-transmissive area of the screen, the optical performance of the TR-LCD, especially in the transmissive part, will not be affected.

6.6—Photovoltaic Solar Power Generating Function

In an embodiment, auxiliary component 802 may comprise one or more semiconductor photovoltaic solar power generating elements (“PV components”) that are embedded in pixels of an LCD panel in the arrangement of either FIG. 8A or FIG. 8B. In a first specific configuration, the PV components are embedded over the shaded gate and source lines of the LCD panel as seen for auxiliary component 802 in the arrangement of FIG. 8B. Alternatively, the PV components may occupy some portion of the reflective part 820 of a pixel as shown in FIG. 8A. In these configurations, an auxiliary component 802 in the form of a PV component is able to receive ambient light and to convert ambient light to electric current. In one embodiment, the PV components may be optimized for conversion of sunlight to electric power and may be coupled through charging circuitry to a battery that powers the LCD panel or a computing device of which the LCD panel forms a part. In this arrangement, when the LCD panel is used in the presence of sunlight the LCD screen can act as a power generating device that recharges the same battery that is used to power the LCD screen and/or the computing device.

In a second specific configuration, the PV components are embedded directly under an underside of a bumpy reflector layer M3 of the reflective part, or are externally attached beneath the bottom layer M1 of the reflective part. In this way, part of the light from the BLU will be absorbed by the PV components through either the photo-energy transformation effect or thermal effect from the BLU and device. Electric power that is produced in this manner may be stored into the battery system to prolong the battery life. The remaining light may be reflected back through a recirculation structure either into the PV components or the transmissive part to improve the brightness of the LCD device.

6.7—Organic LED Structures Providing Quadruple Operating Mode

In an embodiment, auxiliary component 802 may comprise one or more organic light emitting diode (OLED) elements that are embedded in pixels of an LCD panel in the arrangement of either FIG. 8A or FIG. 8B. In one configuration, red, green and blue (RGB) OLEDs are formed in the sub-pixels for corresponding colors as a portion of the reflective part. The RGB OLEDs can be made in the same height of the reflective structure, or formed as a spacer to control the cell gap size of both the transmissive part and reflective part. The increased size of the source and gate driver lines in an amorphous silicon TR-LCD as disclosed herein provides means to drive OLED structures with sufficient voltage and current to provide good performance, which theoretically is not possible in conventional amorphous silicon display panels. In one embodiment, the reflective part has no color filters on the top substrate, and therefore an arrangement using emissive OLEDs can produce a color that is very bright and vivid, which can enhance the color gamut of the transmissive mode and add color in the reflective mode at the same time. Thus, an LCD panel with integrated OLEDs is expected to provide improved color display performance as compared to conventional color LCDs.

In this embodiment, four or five different display modes can be provided. In one embodiment, working modes include:

1. In a location with little ambient light or other dark location, the pixels may operate in a color transmissive mode with color OLED mode, which shows vivid and high content color images with a wide color gamut;

2. In a location with bright ambient light, such as in an office interior, the same pixels may operate in two color modes: 1) OLED-off: transflective LCD mode; 2) transmissive mode-off: OLED with reflective mode;

3. In a location with very bright ambient light, such as outdoors in sunlight, a low power consumption pure black-white reflective LCD mode may be used with both the transmissive LCD mode and OLED off;

4. In a location with very bright ambient light, such as outdoors in sunlight, a color mode with both black-white reflective LCD mode and OLED on while transmissive LCD mode off.

6.8—Eye Tracking Structures

In one implementation, infrared light that emanates from the screen is reflected back toward the screen by the eyeballs of a viewer or viewers. The infrared light may be obtained from an infrared component in the backlight, or for example via an infrared component of a front light, or another source of infrared light that is co-located with the screen. Photodiodes are provided that are sensitive to the infrared light that is reflected back toward the screen from the eyes of the viewer(s).

In an embodiment, a selected area of amorphous silicon of selected pixels is uncovered to form a light-sensitive transistor, and an infrared light emitting diode (IR-LED) is formed in the area of each pixel in which the backlight is normally formed. The uncovered area of amorphous silicon is naturally light sensitive so that an uncovered transistor can operate as an IR-sensitive detector structure that is in or adjacent to a pixel. In one embodiment, approximately every 100^{th} pixel is treated in this manner. The number of pixels having this capability is not particularly critical; in some embodiments every pixel could be structured in the manner described herein, although in some applications the use of every pixel may provide an excess of data or require too much processing power to process in a practical time.

In this embodiment, circuit logic in the LCD panel or its motherboard, or circuit logic, firmware or software in a computer coupled to the LCD panel may be configured to cause emitting infrared (IR) light from the IR-LEDs, and to detect an intensity or magnitude of infrared light that is emitted from the IR-LEDs and reflected off the eyeball back to the IR detectors that are formed elsewhere in the pixel. In an embodiment, the intensity of IR light received at each of the IR detectors may be measured and compared. Detecting, monitoring, measurement and comparison may be continuous or periodic. Detection may comprise time dependent measurement of voltage response from the IR detector structures.

Because the eyeball is generally spherical, it acts as a retro-reflector and will reflect IR light in different directions, but the light that is reflected normal to the center position of the eyeball will reach the IR detectors embedded in the LCD panel with greatest intensity. Thus, the circuit logic or software coupled to the IR detectors can detect a focus position of the eyeball by measuring the relative intensity of IR light that falls on the detectors; the “hot spot” of such reflected light is the point at which the eyeball is focused. The circuit logic or software can report the “hot spot” through an operating system primitive, API function, or other mechanism to one or more application programs that can act on data indicating the “hot spot” by modifying the display, providing pop-up menus, or performing any other desired application program function or operation.

For example, in a video teleconferencing application, the application program may re-calibrate or adjust the position of a camera based on the focal point of the observer. In another application, the operating system or applications of a computer are configured to open a file or other computing element in response to detecting that a user is looking at it. In still another application, the user interface of a computer may be adapted for use, for example, by persons with disabilities, persons working in surgery, foodservice, power plants, or other occupations in which manual computer operation is inconvenient, or persons who prefer not to use a keyboard or pointing device, by responding to specified kinds of blinks, side-to-side eyeball movements, up-and-down eyeball movements, closed and open eyes, and other eye gestures. For example, looking at a point on the computer screen and blinking twice could correspond to a double-click operation using a mouse or other pointing device. Software applications may be configured to learn the manner in which a user looks or makes such eye gestures so that user-dependent eyeball recognition is implemented.

In another application, IR detector structures, appropriate circuitry and software integrated into an LCD flat panel television may be configured to detect whether eyeballs are focused on particular programs, program elements, advertisements, or other aspects of the television display. The resulting data may be communicated over networks to advertisers, broadcasters, cable or satellite head-end facilities, or other locations for analysis and use in determining television program ratings, advertising rates or other feedback.

In this manner, the LCD panel becomes an extended part of a visual display system by looking backward at the user or viewer and self-adjusting the display based on the focus of the user.

In an embodiment, similar techniques may be used to form light-sensitive structures that may form a camera of fixed focal length embedded in the LCD panel. For example, pixel structures of the LCD panel may include capacitive-capacitive-discharge (CCD) camera detector elements such that the LCD panel effectively becomes a flat CCD array camera. Logic coupled to the CCD detector elements may use phased array computation techniques to result in image formation and to compensate for the lack of a lens on the LCD panel. Such an embodiment would overcome the common problem of web cameras and other cameras attached to the top of a display panel in which the receiver of an image perceives that the sender is not looking directly at the camera but appears to be looking down or to the side.

In some embodiments, in which sufficient ambient IR light exists, the use of IR-LEDs in the LCD panel may be unnecessary or the operation of the IR-LEDs may be disabled. For example, operating the IR-LEDs may be necessary only when the user is in a dark room or in a room having a light source that emits relatively little IR light. In contrast, outdoor or daylight conditions may enable the LCD panel, circuits and software to detect reflected ambient IR light without generating active IR light using the IR-LEDs. For this reason, certain embodiments may omit the IR-LED structures altogether and provide only IR detectors embedded in the LCD panel as described above.

7. Extensions and Variations

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention, as described in the claims.

What is claimed is:

1. A liquid crystal display comprising a plurality of pixels, each pixel comprising a plurality of sub-pixels, each sub-pixel comprising:
a transmissive part and an opaque part;
one or more auxiliary components that are in other than the transmissive part of the sub-pixel and that are configured to provide one or more auxiliary functions that do not affect transmissive optical performance of that sub-pixel.

2. The liquid crystal display according to claim 1, wherein the one or more auxiliary components are formed under the opaque part of the sub-pixel.

3. The liquid crystal display according to claim 2, wherein the one or more auxiliary components comprise one or more elements of electronic digital memory logic or drivers.

4. The liquid crystal display according to claim 2, wherein the one or more auxiliary components comprise one or more elements of electronic high refresh rate logic or drivers.

5. The liquid crystal display according to claim 2, wherein one or more touch sensor elements are in or above the opaque part, and the display further comprising a touch panel sheet over the pixels.

6. The liquid crystal display according to claim 2, wherein one or more light sensors are in the opaque part.

7. The liquid crystal display according to claim 2, wherein one or more photodiodes are in the opaque part.

8. The liquid crystal display according to claim 7, further comprising image scanning logic coupled to the one or more photodiodes.

9. The liquid crystal display according to claim 2, wherein one or more photovoltaic solar power generating cells are in the opaque part.

10. The liquid crystal display according to claim 2, wherein one or more organic light emitting diodes are in the opaque part.

11. The liquid crystal display according to claim 10, wherein the one or more auxiliary components comprise one or more organic light emitting diodes and one or more light sensors, and the display further comprising mode switching logic coupled to the light sensors and configured to detect an amount of ambient light incident to the display and, in response thereto, to modify an operational mode of the display by selecting one of a plurality of operational modes of the display.

12. The liquid crystal display according to claim 11 wherein the mode switching logic is further configured to cause:
in response to detecting little ambient light, operating the pixels in a color transmissive mode with the OLEDs on and producing color;
in response to detecting bright ambient light, operating the pixels with OLEDs off and in reflective or transflective LCD mode;
in response to detecting very bright ambient light, operating the pixels in a low power consumption pure black-white reflective LCD mode with transmissive LCD mode off and OLEDs off.

13. The liquid crystal display according to claim 11, wherein the mode switching logic is further configured to cause, in response to detecting very bright ambient light, operating the pixels in a color mode with black-and-white reflective LCD mode on, OLEDs on, and transmissive LCD mode off.

14. The liquid crystal display according to claim 1, wherein the one or more auxiliary components are formed under one or more conductive gate lines or conductive source lines that are coupled to the sub-pixel.

15. The liquid crystal display according to claim 14, wherein the one or more auxiliary components comprise one or more elements of electronic digital memory logic or drivers.

16. The liquid crystal display according to claim 14, wherein the one or more auxiliary components comprise one or more elements of electronic high refresh rate logic or drivers.

17. The liquid crystal display according to claim 14, wherein one or more touch sensor elements are in or under the opaque part, and the display further comprising a touch panel sheet over the pixels.

18. The liquid crystal display according to claim 14, wherein one or more light sensors are in the opaque part.

19. The liquid crystal display according to claim 14, wherein one or more photodiodes are in the opaque part.

20. The liquid crystal display according to claim 19, further comprising image scanning logic coupled to the one or more photodiodes.

21. The liquid crystal display according to claim 14, wherein the one or more auxiliary components comprise one or more photovoltaic solar power generating cells.

22. The liquid crystal display according to claim 14, wherein the one or more auxiliary components comprise one or more organic light emitting diodes.

23. The liquid crystal display according to claim 14, wherein the one or more auxiliary components comprise one or more organic light emitting diodes and one or more light sensors, and the display further comprising mode switching logic coupled to the light sensors and configured to detect an amount of ambient light incident to the display and, in response thereto, to modify an operational mode of the display by selecting one of a plurality of operational modes of the display.

24. The liquid crystal display according to claim 23 wherein the mode switching logic is further configured to cause:
in response to detecting little ambient light, operating the pixels in a color transmissive mode with the OLEDs on and producing color;
in response to detecting bright ambient light, operating the pixels with OLEDs off and in reflective or transflective LCD mode;
in response to detecting very bright ambient light, operating the pixels in a low power consumption pure black-white reflective LCD mode with transmissive LCD mode off and OLEDs off.

25. The liquid crystal display according to claim 23, wherein the mode switching logic is further configured to cause, in response to detecting very bright ambient light, operating the pixels in a color mode with black-and-white reflective LCD mode on, OLEDs on, and transmissive LCD mode off.

26. A computer, comprising:
one or more processors;
a liquid crystal display coupled to the one or more processors and comprising a plurality of pixels, each pixel comprising a plurality of sub-pixels, each sub-pixel comprising:
a transmissive part and an opaque part;
one or more auxiliary components that are in other than the transmissive part of the sub-pixel and that are configured to provide one or more auxiliary functions that do not affect optical performance of that sub-pixel.

27. The computer according to claim 26, wherein the one or more auxiliary components are formed under the opaque part of the sub-pixel.

28. The computer according to claim 27, wherein the one or more auxiliary components comprise one or more elements of electronic digital memory logic or drivers.

29. The computer according to claim 27, wherein the one or more auxiliary components comprise one or more elements of electronic high refresh rate logic or drivers.

30. The computer according to claim 27, wherein one or more touch sensor elements are in or above the opaque part, and the display further comprising a touch panel sheet over the pixels.

31. The computer according to claim 27, wherein one or more light sensors are in the opaque part.

32. The computer according to claim 27, wherein one or more photodiodes are in the opaque part.

33. The computer according to claim 27, wherein one or more photovoltaic solar power generating cells are in the opaque part.

34. The computer according to claim 27, wherein one or more organic light emitting diodes are in the opaque part.

35. The computer according to claim 27, wherein the one or more auxiliary components comprise one or more organic light emitting diodes and one or more light sensors, and the display further comprising mode switching logic coupled to the light sensors and configured to detect an amount of ambient light incident to the display and, in response thereto, to modify an operational mode of the display by selecting one of a plurality of operational modes of the display.

36. The computer according to claim 26, wherein the one or more auxiliary components are formed under one or more conductive gate lines or conductive source lines that are coupled to the sub-pixel.

37. The computer according to claim 36, wherein the one or more auxiliary components comprise one or more elements of electronic digital memory logic or drivers.

38. The computer according to claim 36, wherein the one or more auxiliary components comprise one or more elements of electronic high refresh rate logic or drivers.

39. The computer according to claim 36, wherein one or more touch sensor elements are in or under the opaque part, and further comprising a touch panel sheet over the pixels.

40. The computer according to claim 36, wherein one or more light sensors are in the opaque part.

41. The computer according to claim 36, wherein one or more photodiodes are in the opaque part.

42. The computer according to claim 36, wherein the one or more auxiliary components comprise one or more photovoltaic solar power generating cells.

43. The computer according to claim 36, wherein the one or more auxiliary components comprise one or more organic light emitting diodes.

44. The computer according to claim 36, wherein the one or more auxiliary components comprise one or more organic light emitting diodes and one or more light sensors, and the display further comprising mode switching logic coupled to the light sensors and configured to detect an amount of ambient light incident to the display and, in response thereto, to modify an operational mode of the display by selecting one of a plurality of operational modes of the display.

45. The liquid crystal display according to claim 1, wherein the opaque part of the sub-pixel is a reflective part of a transflective LCD or multi-mode LCD.

46. The liquid crystal display according to claim 1, wherein the one or more auxiliary components are formed in the opaque part of the sub-pixel.

47. The computer according to claim 26, wherein the one or more auxiliary components are formed in the opaque part of the sub-pixel.
